(19) United States
(12) Patent Application Publication
(10) Pub. No.: US 2024/0350891 A1
(43) Pub. Date: Oct. 24, 2024

(54) GAME PROGRAM CONTROL METHOD WITH SPORTS EQUIPMENT AND HUMAN-MACHINE INTERACTION SYSTEM

(71) Applicant: uCare Medical Electronics Co., Ltd., Miaoli County (TW)

(72) Inventors: Fu-An Huang, Miaoli County (TW); Yi-Zhe Tsai, Miaoli County (TW)

(73) Assignee: uCare Medical Electronics Co., Ltd., Miaoli County (TW)

(21) Appl. No.: 18/634,968

(22) Filed: Apr. 14, 2024

(30) Foreign Application Priority Data
Apr. 21, 2023 (TW) 112115004

(51) Int. Cl. A63B 71/06; A63B 24/00

(52) U.S. Cl. CPC A63B 71/0622; A63B 24/0062; A63B 2024/0096; A63B 2071/0638; A63B 2220/05; A63B 2220/807

(57) ABSTRACT

A game program control method with sports equipment includes the following steps: capturing a user image of a user operating the sports equipment; analyzing the user image to detect a position of at least one body part of the user; obtaining an angle between a target direction corresponding to the position and a base direction; moving a target object in the game program according to the position if the angle is greater than a threshold angle; and maintaining the target object at a current position of the target object if the angle is not greater than the threshold angle. A human-computer interaction system is also provided.

### CROSS-REFERENCE TO RELATED APPLICATION

This application claims the priority benefit of Taiwan application serial no. 112115004, filed on Apr. 21, 2023. The entirety of the above-mentioned patent application is hereby incorporated by reference herein and made a part of this specification.

### BACKGROUND

### Technical Field

The disclosure relates to a human-computer interaction system, and in particular, to a game program control method with sports equipment and a human-computer interaction system.

### Description of Related Art

Generally, the display interface of sports equipment such as a treadmill, a rowing machine, or a spinning bike, displays only information related to the current use status of the sports equipment, such as resistance value, use time, and/or user's heart rate, etc., and the display of other entertainment (e.g., games) functions is not supported. If it is desired to execute a game program at the same time when the user operates the sports equipment, the user often needs to input control information to the game program through an additional device (e.g., a smart phone, a tablet computer, or a controller) in addition to using the information (e.g., rotation speed of wheels) provided by the sports equipment itself. It is thus inevitable for the user to experience inconvenience.

The information disclosed in this BACKGROUND section is only for enhancement of understanding of the background of the described technology and therefore it may contain information that does not form the prior art that is already known to a person of ordinary skill in the art. Further, the information disclosed in the Background section does not mean that one or more problems to be resolved by one or more embodiments of the invention was acknowledged by a person of ordinary skill in the art.

### SUMMARY

An embodiment of the disclosure provides a game program control method with sports equipment, and the method includes the following steps. A user image of a user operating the sports equipment is captured. The user image is analyzed to detect a position of at least one body part of the user. An angle between a target direction corresponding to the position of the at least one body part and a base direction is obtained. If the angle is greater than a threshold angle, target object in the game program is moved according to the position of the at least one body part. If the angle is not greater than the threshold angle, the target object is maintained at a current position of the target object.

An embodiment of the disclosure further provides a human-computer interaction system including a signal transmission interface, a camera device, a storage device, and a processor. The signal transmission interface is configured to be coupled to sports equipment. The camera device is configured to capture a user image of a user operating the sports equipment. The storage device is configured to store a game program and the user image. The processor is coupled to the signal transmission interface, the camera device, and the storage device. The processor is configured to analyze the user image to detect a position of at least one body part of the user, obtain an angle between a target direction corresponding to the position of the at least one body part and a base direction, move a target object in the game program according to the position of the at least one body part if the angle is greater than a threshold angle, and maintain the target object at a current position of the target object if the angle is not greater than the threshold angle.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view illustrating a human-computer interaction system and sports equipment according to an embodiment of the disclosure.

FIG. 2 is a schematic view of a user operating the sports equipment according to an embodiment of the disclosure.

FIG. 3 to FIG. 8 are schematic diagrams of operating scenarios of a game program control method with the sports equipment according to an embodiment of the disclosure.

FIG. 9 is a schematic diagram of obtaining a target direction corresponding to a body part of the user according to an embodiment of the present invention.

FIG. 10 is a schematic diagram illustrating different distances between a first target body part and a second target body part according to an embodiment of the disclosure.

FIG. 11 is a flow chart of a game program control method with sports equipment according to an embodiment of the disclosure.

### DESCRIPTION OF THE EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

The foregoing and other technical contents, features and effects of the disclosure may be clearly presented in the following detailed description of one of the preferred embodiments with the reference drawings. The directional terms mentioned in the following embodiments, such as up, down, left, right, front, back, or the like, only refer to the directions of the accompanying drawings. As a result, the directional terms are used for illustrating instead of limiting the disclosure.

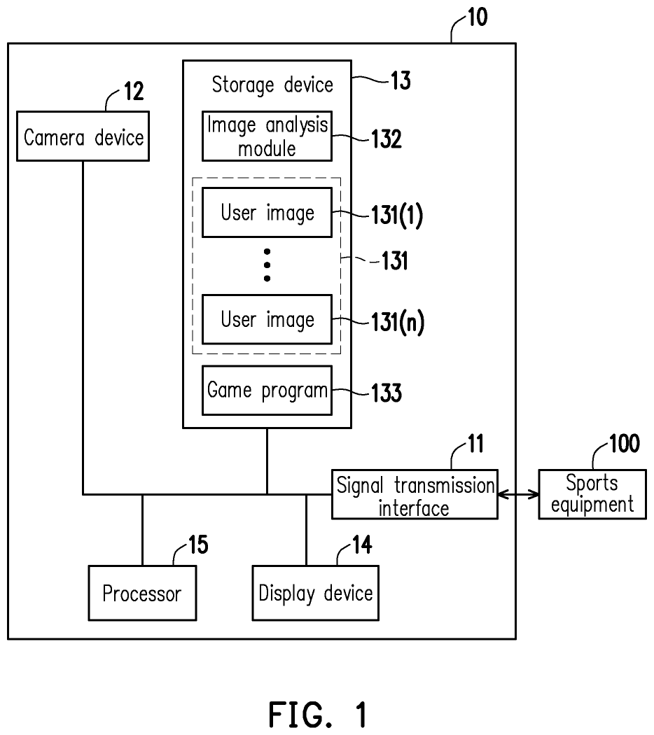

FIG. 1 is a schematic view illustrating a human-computer interaction system and sports equipment according to an embodiment of the disclosure.

With reference to FIG. 1, a human-computer interaction system 10 may be used together with sports equipment 100. The sports equipment 100 may be operated by a user to perform various sports. For instance, the sports equipment 100 may include various sports equipment such as a treadmill, a rowing machine, or a spinning bike, and the type of the sports equipment 100 is not limited by the disclosure.

The human-computer interaction system 10 may include a signal transmission interface 11, a camera device 12, a storage device 13, a display device 14 and a processor 15. The signal transmission interface 11 is configured to couple the human-computer interaction system 10 to the sports equipment 100. Further, the signal transmission interface 11 may be configured to transmit a signal between the human-computer interaction system 10 and the sports equipment 100. For instance, the signal transmission interface 11 may comply with various wired or wireless communication standards such as Bluetooth, Universal Serial Bus (USB), Universal Asynchronous (UART), or Wireless Fidelity (WiFi), and the communication standards supported by the signal transmission interface 11 are not limited thereto.

The camera device 12 may be configured to capture an image. For instance, the camera device 12 may include a camera built into the sports equipment 100 or a camera externally connected to the sports equipment 100. For instance, the camera device 12 may include basic components such as a lens and a photosensitive element to form an image capturing module, and the type of the camera device 12 is not limited by the disclosure.

The storage device 13 may be configured to store data. For instance, the storage device 13 may include a volatile storage circuit and a non-volatile storage circuit. The volatile storage circuit is configured for volatile storage of data. For instance, the volatile storage circuit may include a random access memory (RAM) or similar volatile storage media. The non-volatile storage circuit is used for non-volatile storage of data. For example, the non-volatile storage circuit may include a read only memory (ROM), a solid state disk (SSD), a conventional hard disk drive (HDD), or similar non-volatile storage media.

The display device 14 is configured to display an image. For instance, the display device 14 may include a plasma display, a liquid crystal display (LCD), a thin film transistor (TFT) LCD, a light emitting diode (LED) display, an organic LED (OLED), or various types of displays.

The processor 15 is coupled to the signal transmission interface 11, the camera device 12, the storage device 13, and the display device 14. The processor 15 may be responsible for the entire or part of the operation of the human-computer interaction system 10. For instance, the processor 15 may be a central processing unit (CPU), a graphics processing unit (GPU), a programmable microprocessor for general or special use, a digital signal processor (DSP), a programmable controller, an application specific integrated circuit (ASIC), a programmable logic device (PLD), other similar devices, or a combination of the foregoing devices.

In an embodiment, the camera device 12 may be configured to capture an image (also referred to as a user image) 131 of a user who is operating the sports equipment 100. The captured user image 131 may be stored in the storage device 13. The number of the user image 131 may be one or plural. In an embodiment, the user image 131 includes user images 131(1) to 131 (n), and n may be any integer greater than 1. The user images 131(1) to 131 (n) may include user images captured by the camera device 12 within one or more time ranges.

In an embodiment, the storage device 13 may store an image analysis module 132. For instance, the image analysis module 132 may be implemented as a software program. The image analysis module 132 may be configured to perform image analysis on the user image 131 to detect a specific object in the user image 131. For instance, the image analysis module 132 may be configured to detect various body parts such as the user's head, face, eyes (including eye contours and/or eyeballs), eyebrows, mouth, nose, ears, shoulders, neck, upper body, or lower body in the user image 131. Further, the types of body parts of the user that can be detected by the image analysis module 132 are not limited thereto. In an embodiment, the image analysis module 132 may also be implemented as a hardware circuit.

In an embodiment, the image analysis module 132 may include a deep learning model or a machine learning model. The image analysis module 132 may be trained to improve image recognition efficiency. For instance, in the process of training the image analysis module 132, a plurality of training images may be input to the image analysis module 132. The image analysis module 132 may analyze the received training images and provide an image recognition result. For instance, the image recognition result may reflect whether the image analysis module 132 detects a specific object in the training image. After verification data is used to verify the image recognition result generated by the image analysis module 132, a decision parameter (e.g., a weight value) inside the image analysis module 132 may be adjusted, so that the image recognition efficiency of the image analysis module 132 may be gradually improved.

In an embodiment, the storage device 13 may store a game program 133. The number of the game program 133 may be one or plural. The processor 15 may run the game program 133 to execute at least one game. The executed game may include an action game, a shooting game, or a puzzle game, and the type of the game program 133 is not limited by the disclosure. In an embodiment of FIG. 1, the image analysis module 132, the user image 131, and the game program 133 are different programs stored in the storage device 13 separately, but in other embodiments, they may be integrated in pairs or all three integrated into one program. The disclosure is not limited thereto.

In an embodiment, the processor 15 may present a game image corresponding to the game program 133 via the display device 14. That is, during the execution of the game program 133, the game image corresponding to the game program 133 may be presented by the display device 14. In addition, during the execution of the game program 133, the processor 15 may present at least one object (also referred to as a target object) in the game image corresponding to the game program 133. For instance, the target object may be any object in the game image, such as a game prop, a game character, a vehicle or, a cursor, etc., and the type of the target object is not limited thereto.

In an embodiment, at least part of the electronic devices in the human-computer interaction system 10 (e.g., at least one of the signal transmission interface 11, the camera device 12, the storage device 13, the display device 14, and the processor 15) may also be provided by a portable electronic device such as a smart phone or a tablet computer. The user only needs to connect the portable electronic device to the sports equipment 100 through the signal transmission interface 11, and the user can then execute relevant operation functions through the human-computer interaction system 10.

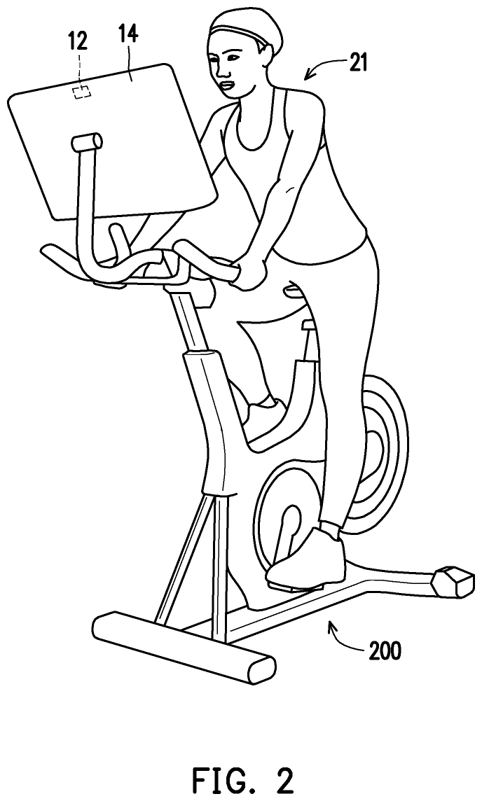

FIG. 2 is a schematic view of a user operating the sports equipment according to an embodiment of the disclosure.

With reference to FIG. 1 and FIG. 2, in an embodiment, the sports equipment 100 includes a spinning bike 200. When the user 21 is operating the spinning bike 200, the display device 14 may present a game image corresponding to the game program 133 for the user to watch, and the camera device 12 may be configured to capture the user image 131 of the user 21. For instance, the user image 131 may present a position of at least one body part where the user 21 currently operates the spinning bike 200. It should be noted that the sports equipment 100 may also include other types of sports equipment, not limited to the spinning bike 200. In addition, the types and installation positions of the camera device 12 and the display device 14 may also be adjusted according to practical needs, which are not limited by the disclosure.

In an embodiment, when the processor 15 is running the game program 133, the processor 15 can capture the user image 131 through the camera device 12. The processor 15 can analyze the user image 131 through the image analysis module 132 to detect the position of at least one body part of the user (e.g., the user 21 in FIG. 2). For instance, the body part may include the user's head, face, eyes (including eye contours and/or eyeballs), eyebrows, mouth, nose, ears, shoulders, neck, upper body, or lower body, and so on, and the body part may also include other body parts of the user.

In an embodiment, according to the detected position of the at least one body part, the processor 15 may further obtain an angle between a direction corresponding to the position of the at least one body part (also referred to as a target direction) and a base direction. The processor 15 may then determine whether the angle is greater than a threshold angle. If (or in response to) the angle is greater than the threshold angle, the processor 15 may move the target object according to the position of the at least one body part. In addition, if (or in response to) the angle is not greater than the threshold angle, the processor 15 may maintain the target object at the current position of the target object.

In an embodiment, in the case that the angle is greater than the threshold angle, the processor 15 may determine a moving direction of the target object according to the position of the at least one body part. For instance, the determined moving direction of the target object and the position of the at least one body part may correspond to each other. The processor 15 can then control the target object to move in this moving direction.

In an embodiment, if the angle is greater than the threshold angle, the processor 15 may control a moving distance of the target object in the moving direction according to maintaining time during which the angle is greater than the threshold angle. For instance, the maintaining time may be positively related to the moving distance. For instance, in the case that the angle is greater than the threshold angle, if the time for which the angle is maintained greater than the threshold angle is longer (i.e., the longer the maintaining time is), the processor 15 may continuously increase the moving distance of the target object in the moving direction. However, if (or in response to) the angle is not greater than the threshold angle, the processor 15 may stop moving the target object (i.e., maintain the target object at the current position of the target object).

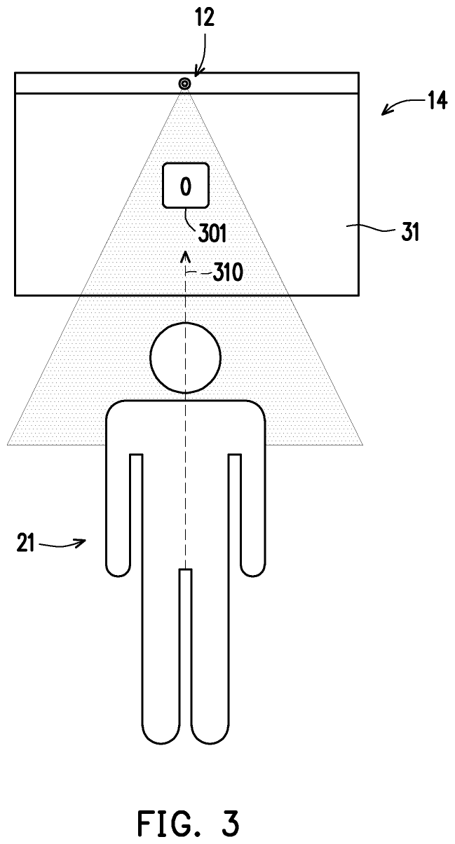

FIG. 3 to FIG. 8 are schematic diagrams of operating scenarios of a game program control method with the sports equipment according to an embodiment of the disclosure.

With reference to FIG. 3, the triangular area marked with shading presents the image capturing range of the camera device 12. Within the image capturing range, the camera device 12 may capture the user image 131 of the user 21 who is operating the sports equipment 100 (e.g., the spinning bike 200 in FIG. 2) in front of the camera device 12. In addition, the display device 14 may present the game image 31 corresponding to the game program 133 on the display interface, and an object 301 (i.e., the target object) may be displayed in the game image 31. For instance, the object 301 may appear at a position “0” in the game image 31. It should be noted that the object 301 may be used to represent various types of target objects in the game program 133, and description thereof is not repeated herein.

In an embodiment, a baseline 310 may be configured to present the base direction. For instance, in the two-dimensional plane (also referred to as the X-Y plane) where the user image 131 is located, the X-axis direction and the Y-axis direction in the two-dimensional plane are perpendicular to each other, and the baseline 310 may be parallel to the Y-axis direction of the two-dimensional plane. In addition, the setting of the base direction may also be adjusted according to practical needs. In particular, when the user 21 is at the operating position of the sports equipment 100 (e.g., the spinning bike 200 in FIG. 2) and does not move (or swing) at least one body part left and right, in the user image 131, the direction (i.e., the target direction) corresponding to the position of the at least one body part of the user 21 may be parallel to the base direction (i.e., the baseline 310), as shown in FIG. 3. For instance, the target direction may reflect or be parallel to the orientation of the at least one body part of the user 21. In an embodiment, in the case that the target direction is parallel to the base direction, the angle between the target direction and the base direction (i.e., the baseline 310) may be or may approach to 0 degrees.

In an embodiment, when the user 21 operates the sports equipment 100, the user 21 may dynamically move or swing the at least one body part to change the position of the at least one body part. As the position of the at least one body part changes, the target direction corresponding to the position of the body part also changes correspondingly.

In an embodiment, if (or in response to) the user image 131 reflects that the angle between the target direction corresponding to the position of at least one body part of the user 21 and the baseline 310 is greater than a threshold angle ⊖(th), the processor 15 may move the object 301 according to the position of the at least one body part. In contrast, if (or in response to) the user image 131 reflects that the angle between the target direction corresponding to the position of at least one body part of the user 21 and the baseline 310 is not greater than the threshold angle ⊖(th), the processor 15 may not move the object 301 (that is, maintain the object 301 at its current position).

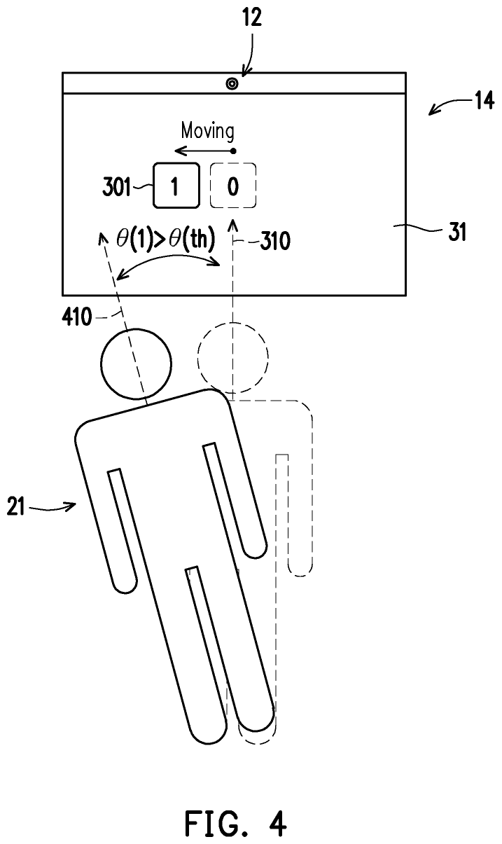

With reference to FIG. 4, in an embodiment, during the operation of the sports equipment 100 by the user 21, it is assumed that the user image 131 reflects that at a specific time point, an angle ⊖(1) between a target direction 410 corresponding to the position of at least one body part of the user 21 and the baseline 310 is greater than the threshold angle ⊖(th). In this case, the processor 15 may move the object 301 according to the position of the at least one body part. For instance, in the embodiment of FIG. 4, in response to the position of the at least one body part being shifted to the left in a direction facing the display device 14, the processor 15 may control the object 301 to move from the position “0” to a position “1” in the game image 31 (i.e., moving the object 301 towards the left side of the display device 14 or the game image 31).

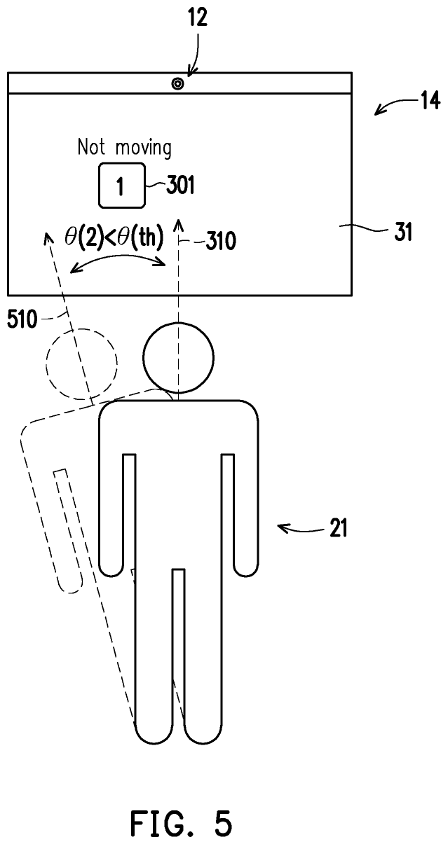

With reference to FIG. 5, following the embodiment of FIG. 4, in an embodiment, during the operation of the sports equipment 100 by the user 21, it is assumed that the user image 131 reflects that at a specific time point, an angle ⊖(2) between a target direction 510 corresponding to the position of the at least one body part of the user 21 and the baseline 310 is not greater than the threshold angle ⊖(th). For instance, the at least one body part of the user 21 at this time is returning to normal from the left side in the direction facing the display device 14. In this case, the processor 15 may maintain the object 301 at its current position (i.e., not moving the object 301). For instance, in the embodiment of FIG. 5, if the at least one body part of the user 21 is being pulled back to align with the center of the display device 14 from the left side in the direction facing the display device 14, the object 301 may be maintained at the position “1” in the game image 31 and is not moved.

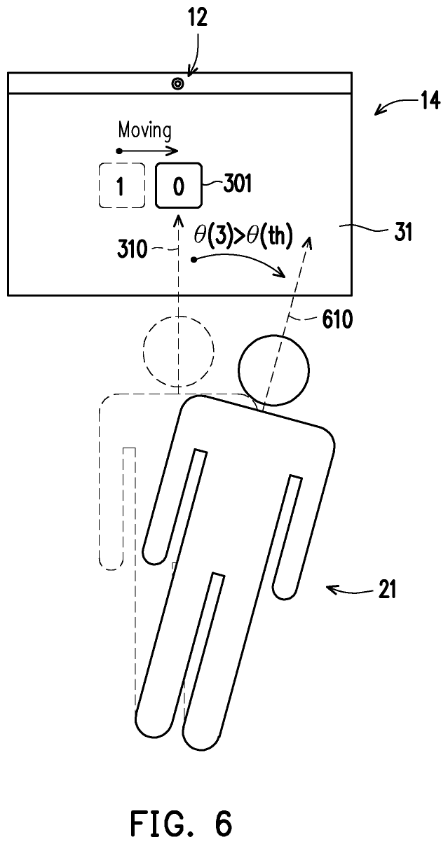

With reference to FIG. 6, following the embodiment of FIG. 5, in an embodiment, during the operation of the sports equipment 100 by the user 21, it is assumed that the user image 131 reflects that at a specific time point, an angle ⊖(3) between a target direction 610 corresponding to the position of at least one body part of the user 21 and the baseline 310 is greater than the threshold angle ⊖(th). In this case, the processor 15 may move the object 301 according to the position of the at least one body part. For instance, in the embodiment of FIG. 6, in response to the position of the at least one body part being shifted to the right in the direction facing the display device 14, the processor 15 may control the object 301 to move from the position “1” to the position “0” in the game image 31 (i.e., moving the object 301 towards the right side of the display device 14 or the game image 31).

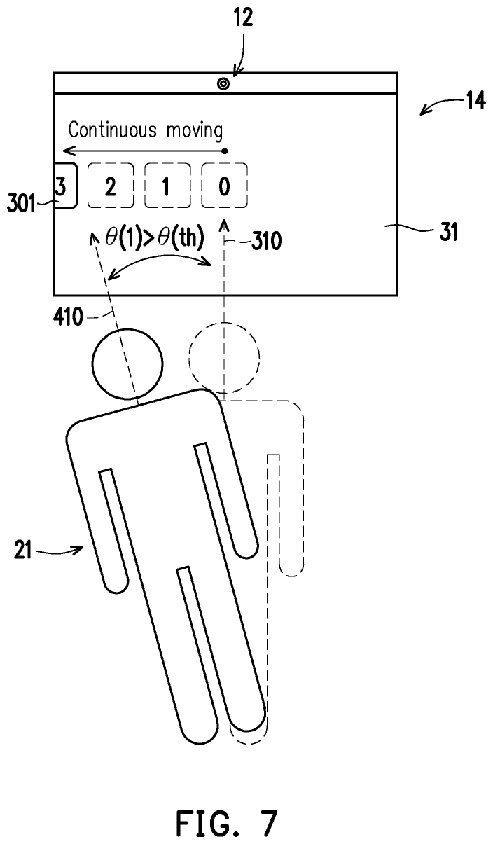

With reference to FIG. 7, following the embodiment of FIG. 4, in an embodiment, it is assumed that the user image 131 reflects that at multiple consecutive time points, the angle ⊖(1) between the target direction 410 corresponding to the position of at least one body part of the user 21 and the baseline 310 is continuously greater than the threshold angle ⊖(th). In this case, according to the maintaining time during which the angle ⊖(1) is greater than the threshold angle ⊖(th), the processor 15 may increase the moving distance of the object 301 in the current moving direction until the angle ⊖(1) is no longer greater than the threshold angle ⊖(th). For instance, in the embodiment of FIG. 7, the processor 15 may control the object 301 to continuously move from the position “0” in the game image 31 to the positions “1”, “2”, and “3” according to the increase in the time during which the angle ⊖(1) is maintained greater than the threshold angle ⊖(th)”.

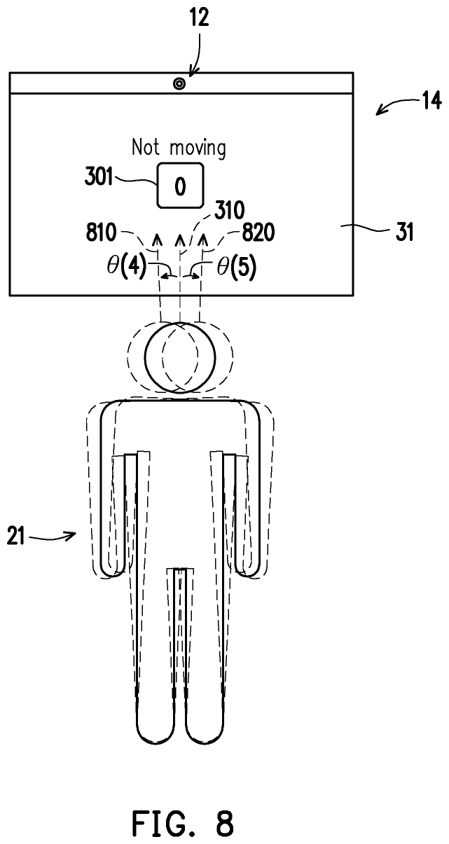

With reference to FIG. 8, in an embodiment, it is assumed that the user image 131 reflects that an angle ⊖(4) between a target direction 810 corresponding to the position of at least one body part of the user 21 and the baseline 310 at a specific time point or an angle ⊖(5) between a target direction 820 corresponding to the position of at least one body part of the user 21 and the baseline 310 at another specific time point is not greater than the threshold angle ⊖(th). In this case, the processor 15 may maintain the object 301 at its current position (i.e., not moving the object 301).

In other words, in the embodiments of FIG. 4, FIG. 6, and FIG. 7, the angles (i.e., the angles ⊖(1) and ⊖(3)) between the target directions (i.e., the target directions 410 and 610) corresponding to the positions of at least one body part of the user 21 and the baseline 310 are both greater than the threshold angle ⊖(th). In response to the angle being greater than the threshold angle ⊖(th), the processor 15 may determine that the user 21 intends to move the object 301 at the moment and correspondingly moves the object 301. In contrast, in the embodiments of FIG. 5 and FIG. 8, the angles (i.e., the angles ⊖(2), ⊖(4), and ⊖(5)) between the target directions (i.e., the target directions 510, 810, and 820) corresponding to the positions of at least one body part of the user 21 and the baseline 310 are not greater than (e.g., less than or equal to) the threshold angle ⊖(th). In response to the angle not being greater than the threshold angle ⊖(th), the processor 15 may determine that the user 21 does not intend to move the object 301 at the moment and correspondingly does not move the object 301.

It should be noted that in the embodiments of FIG. 3 to FIG. 8, the left and right movement of the target object (i.e., the object 301) in the game image 31 is treated as an example. However, in another embodiment, the aforementioned movement control of the target object may also refer to rotation control of the target object. For instance, controlling the target object to move left or right may also refer to controlling the target object to rotate left or right.

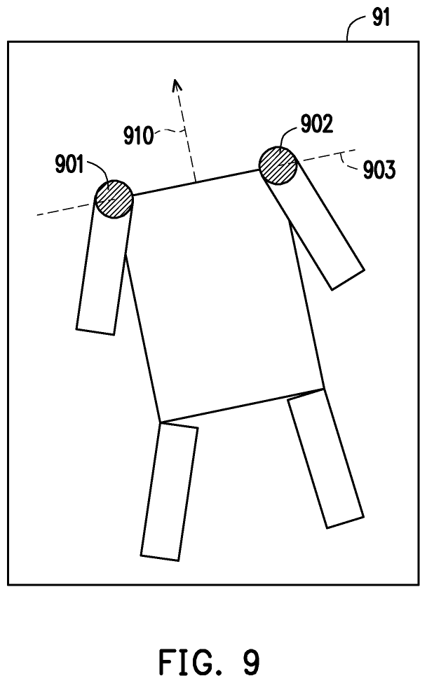

FIG. 9 is a schematic diagram of obtaining a target direction corresponding to a body part of the user according to an embodiment of the present invention.

With reference to FIG. 1 to FIG. 9, in an embodiment, it is assumed that the user image 131 includes a user image 91, and the body part is the shoulders of the user (e.g., the user 21 in FIG. 2). The processor 15 may analyze the user image 91 through the image analysis module 132 to detect the positions of the user's shoulders. The processor 15 may then obtain the target direction corresponding to the position of the at least one body part according to the positions of the shoulders of the user.

In an embodiment, the processor 15 may detect at least two feature points 901 and 902 of the shoulders in the user image 91 of the user through the image analysis module 132. The feature points 901 and 902 may reflect the positions of the user's left and right shoulders in the user image 91. The processor 15 may then establish a connecting line 903 between the feature points 901 and 902. After the connecting line 903 is established, the processor 15 may obtain a direction line 910 correspondingly. The direction line 910 and the connecting line 903 are perpendicular to each other in the two-dimensional direction. Herein, the direction indicated by the direction line 910 is the target direction.

It should be noted that in the embodiment of FIG. 9, the user's shoulders are treated as an example of the body part. However, in an embodiment, the body part may also include the user's head, face, eyes (including eye contours and/or eyeballs), eyebrows, mouth, nose, ears, neck, upper body, or lower body and the like. Taking the user's eyes (or eyeballs) as an example, in an embodiment, the feature points 901 and 902 in FIG. 9 may also reflect the positions of the user's eyes (or two eyeballs) in the user image 91. The rest of the operation details have been described in detail in the foregoing paragraphs, and description thereof is not to be repeated herein.

With reference to FIG. 1 again, in an embodiment, the processor 15 may also receive status data of the sports equipment 100 through the signal transmission interface 11. For instance, the status data may reflect the operating status of the sports equipment 100. Taking the spinning bike 200 in FIG. 2 as an example, the status data from the sports equipment 100 may reflect information such as the current wheel speed and/or the currently set wheel resistance of the spinning bike 200. Alternatively, if the sports equipment 100 is a treadmill, the status data from the sports equipment 100 may reflect the user's current running speed and/or the currently-set belt resistance. By analogy, different types of sports equipment 100 may transmit different types of status data to the processor 15.

In an embodiment, the processor 15 may set part of the control parameters of the game program 133 according to the status information. For instance, when the status data from the sports equipment 100 reflects that the user is currently operating the sports equipment 100 for a full sprint, the processor 15 may correspondingly accelerate the forward speed of the target object in the corresponding game scene. Alternatively, when the status data from the sports equipment 100 reflects that the user is currently operating the sports equipment 100 easily and slowly, the processor 15 may correspondingly slow down the forward speed of the target object in the corresponding game scene. In addition, the processor 15 may also set the remaining control parameters in the game program 133 according to the status information, depending on practical needs.

In an embodiment, the processor 15 may also analyze the user image 131 through the image analysis module 132 to detect distances among a plurality of body parts of the user. For instance, the plurality of body parts may include a first target body part and a second target body part. The processor 15 may detect a distance between the first target body part and the second target body part through the image analysis module 132. The processor 15 may then adjust the control parameter of at least one of the sports equipment 100 and the game program 133 according to a change in the distance.

In an embodiment, the first target body part and the second target body part may be eyes and shoulders of the user respectively, but the disclosure is not limited thereto. In an embodiment, both the first target body part and the second target body part may be set as other body parts of the user, depending on practical needs.

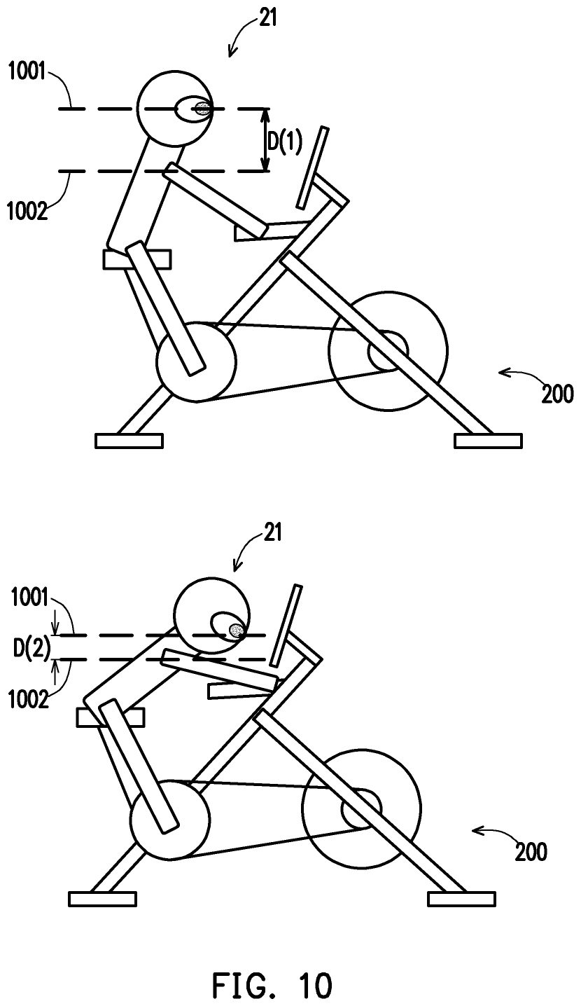

FIG. 10 is a schematic diagram illustrating different distances between a first target body part and a second target body part according to an embodiment of the disclosure.

With reference to FIG. 1 and FIG. 10, a level height of eyes (i.e., the first target body part) of the user 21 is indicated by a marking line 1001, and a level height of shoulders (i.e., the second target body part) of the user 21 is indicated by a marking line 1002. At a specific time point, it is assumed that the distance between the first target body part (i.e., the marking line 1001) and the second target body part (i.e., the marking line 1002) of the user 21 is D(1). At this time, the user 21 operates the spinning bike 200 in a relatively upper body upright posture. According to the distance D(1), the processor 15 may set a specific control parameter of at least one of the sports equipment 100 and the game program 133 to a specific value (also referred to as a first value). For instance, this specific control parameter may affect the wheel resistance of the spinning bike 200, the wind resistance experienced by the target object moving forward in the game, and/or the acceleration of the target object moving forward in the game.

On the other hand, at another time point, it is assumed that the distance between the first target body part (i.e., the marking line 1001) and the second target body part (i.e., the marking line 1002) of the user 21 changes to D(2). The distance D(1) is greater than the distance D(2). At this time, the user 21 operates the spinning bike 200 in a relatively upper body prone posture. According to the distance D(2), the processor 15 may set the specific control parameter of at least one of the sports equipment 100 and the game program 133 to a specific value (also referred to as a second value). The first value is different from the second value.

In an embodiment, by switching the specific control parameter between the first value and the second value (or other values), the wheel resistance of the spinning bike 200, the wind resistance experienced by the target object moving forward in the game, and/or the acceleration of the target object moving forward in the game may be changed. For instance, compared to the second value, the first value can increase the wheel resistance of the spinning bike 200, increase the wind resistance experienced by the target object moving forward in the game, and/or reduce the acceleration of the target object moving forward in the game. In contrast, compared to the first value, the second value can decrease the wheel resistance of the spinning bike 200, decrease the wind resistance experienced by the target object moving forward in the game, and/or increase the acceleration of the target object moving forward in the game. In this way, when the user 21 operates the spinning bike 200 in a upper body prone position (at this time, the distance between the first target body part and the second target body part is D(2)), the user 21 may feel that it is easier for the target object to move forward in the game.

It should be noted that in the embodiment of FIG. 10, the distance between the first target body part and the second target body part is used as a basis for adjusting some of the control parameters of the sports equipment 100 and/or the game program 133. However, in an embodiment, the processor 15 may also adjust some of the control parameters of the sports equipment 100 and/or the game program 133 according to the user's body posture in the user image 131. For instance, in another embodiment of FIG. 10, the processor 15 may also adjust some of the control parameters of the sports equipment 100 and/or the game program 133 correspondingly according to whether a upper body of the user 21 is operating the spinning bike 200 in an upright, prone, or other types of body postures presented by the user image 131, so that the user 21 may enjoy a favorable gaming experience when playing games. The relevant parameter adjustment methods have been described in detail above and can be adjusted according to practical needs.

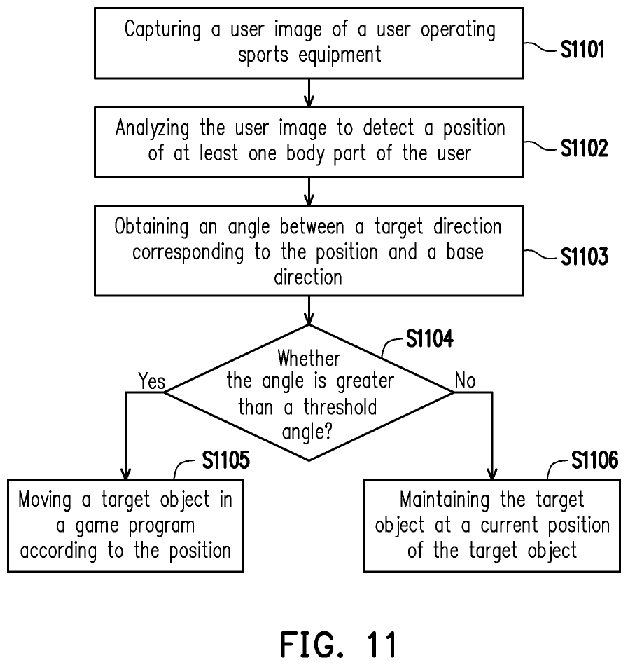

FIG. 11 is a flow chart of a game program control method with sports equipment according to an embodiment of the disclosure.

With reference to FIG. 11, in step S1101, a user image of a user operating the sports equipment is captured. In step S1102, the user image is analyzed to detect a position of at least one body part of the user. In step S1103, an angle between a target direction corresponding to the position of the at least one body part and a base direction is obtained. In step S1104, it is determined whether the angle is greater than a threshold angle. If the angle is greater than the threshold angle, in step S1105, a target object in the game program is moved according to the position of the at least one body part. In addition, if the angle is not greater than the threshold angle, in step S1106, the target object is then maintained at a current position of the target object.

Each step of FIG. 11 has been described in detail in the foregoing paragraphs, and description thereof is thus not repeated herein. It should be noted that each step of FIG. 11 may be implemented as a plurality of program codes or circuits, which is not particularly limited by the disclosure. In addition, the method of FIG. 11 may be used in combination with the above-described exemplary embodiments or may be used solely, which is not particularly limited by the disclosure.

In view of the foregoing, during the operation of the sports equipment by the user, the user can control the movement of the target object in the game program by moving specific body parts (such as shaking the head, shrugging the shoulders, swinging the body, or rolling the eyes) to overcome different game levels. In particular, only when the angle between the target direction corresponding to the position of the specific body part and one base direction is greater than the threshold angle, the target object will move correspondingly in response to the moving action of the specific body part. In this way, during the operation of the sports equipment by the user, the human-computer interaction system can accurately control the movement of the target object simply through the position changes of the user's body part and filter out false actions that are not related to the user's control intention. In this way, the gaming experience experienced by the user when operating the sports equipment may be effectively improved.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A game program control method with sports equipment, comprising:
capturing a user image of a user operating the sports equipment;
analyzing the user image to detect a position of at least one body part of the user;
obtaining an angle between a target direction corresponding to the position of the at least one body part and a base direction;
moving a target object in the game program according to the position of the at least one body part if the angle is greater than a threshold angle; and
maintaining the target object at a current position of the target object if the angle is not greater than the threshold angle.

2. The game program control method with the sports equipment according to claim 1, wherein the step of moving the target object in the game program according to the position of the at least one body part comprises:
determining a moving direction of the target object according to the position of the at least one body part; and
controlling the target object to move towards the moving direction.

3. The game program control method with the sports equipment according to claim 2, wherein the step of controlling the target object to move towards the moving direction comprises:
controlling a moving distance of the target object in the moving direction according to maintaining time during which the angle is greater than the threshold angle.

4. The game program control method with the sports equipment according to claim 3, wherein the maintaining time is positively related to the moving distance.

5. The game program control method with the sports equipment according to claim 1, further comprising:
analyzing the user image to detect a distance between a first target body part and a second target body part of the user; and
adjusting a control parameter of at least one of the sports equipment and the game program according to a change in the distance.

6. The game program control method with the sports equipment according to claim 1, further comprising:
presenting a game image corresponding to the game program via a display device; and
presenting the target object in the game image.

7. A human-computer interaction system, comprising:
a signal transmission interface configured to be coupled to sports equipment;
a camera device configured to capture a user image of a user operating the sports equipment;
a storage device configured to store a game program and the user image; and
a processor coupled to the signal transmission interface, the camera device, and the storage device,
wherein the processor is configured to:
analyze the user image to detect a position of at least one body part of the user,
obtain an angle between a target direction corresponding to the position of the at least one body part and a base direction,
move a target object in the game program according to the position of the at least one body part if the angle is greater than a threshold angle, and
maintain the target object at a current position of the target object if the angle is not greater than the threshold angle.

8. The human-computer interaction system according to claim 7, wherein the operation of the processor moving the target object in the game program according to the position of the at least one body part comprises:
determine a moving direction of the target object according to the position of the at least one body part, and
control the target object to move towards the moving direction.

9. The human-computer interaction system according to claim 8, wherein the operation of the processor controlling the target object to move towards the moving direction comprises:
control a moving distance of the target object in the moving direction according to maintaining time during which the angle is greater than the threshold angle.

10. The human-computer interaction system according to claim 9, wherein the maintaining time is positively related to the moving distance.

11. The human-computer interaction system according to claim 7, wherein the processor is further configured to:
analyze the user image to detect a distance between a first target body part and a second target body part of the user, and
adjust a control parameter of at least one of the sports equipment and the game program according to a change in the distance.

12. The human-computer interaction system according to claim 7, further comprising:
a display device coupled to the processor,
wherein the display device is configured to present a game image corresponding to the game program, and the processor is further configured to present the target object in the game image.
